(19) United States
(12) Patent Application Publication
(10) Pub. No.: US 2009/0161926 A1
(43) Pub. Date: Jun. 25, 2009

(54) Semi-automatic Segmentation of Cardiac Ultrasound Images using a Dynamic Model of the Left Ventricle

(75) Inventors: Charles Florin, Exton, PA (US); Nikolaos Paragios, Vincennes (FR); Gareth Funka-Lea, Cranbury, NJ (US); James Williams, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Corporate Research, Inc., Princeton, NJ (US)

(21) Appl. No.: 12/028,884

(22) Filed: Feb. 11, 2008

Related U.S. Application Data
(60) Provisional application No. 60/889,560, filed on Feb. 13, 2007.

(51) Int. Cl. G06K 9/00; G06K 9/34

(52) U.S. Cl. 382/128; 382/173

(57) ABSTRACT

A method for segmenting a sequence of images includes developing an autoregressive model using training data including segmented images of a same type as the sequence of images. The sequence of images showing a progression of a subject through a cycle is acquired. At least two images from the sequence of images are identified. A region of interest is manually segmented from the identified images. The manually segmented images are parameterized. The autoregressive model is adapted to the parameterized segmented images. The autoregressive model is used to perform segmentation on the region of interest for a plurality of images of the sequence of images.

### CROSS-REFERENCE TO RELATED APPLICATION

The present application is based on provisional application Ser. No. 60/889,560, filed Feb. 13, 2007, the entire contents of which are herein incorporated by reference.

### BACKGROUND OF THE INVENTION

1. Technical Field

The present disclosure relates to segmentation of cardiac ultrasound images and, more specifically, to semi-automatic segmentation of cardiac ultrasound images using dynamic model of the left ventricle.

2. Discussion of the Related Art

Echocardiography is the process of acquiring a cardiac ultrasound image. Cardiac ultrasound images may be either two or three dimensional and may illustrate the geometric configuration of the heart as it progresses thought the cardiac cycle. This geometric data may be used to provide a variety of useful information such as the size and shape of the heart, pumping capacity and the location and extent of damage to tissue. This data may then be particularly useful in diagnosing cardiovascular disease. Of particular diagnostic value is data related to the left ventricle (LV).

The cardiac ultrasound may include a large number of image frames, with each image frame representing a snapshot of the LV or the entire heart at a particular point in the cardiac cycle. Cardiac ultrasounds may capture upwards of 20 frames per second. From this sequence of cardiac ultrasounds, medical practitioners such as radiologists and technicians may be able to identify an end systolic (ES) frame representing the geometry of the LV at the end of the ventricular systole stage and an end diastole (ED) frame representing the geometry of the LV at the end of the diastole stage.

At the ES frame, the volume of the LV is minimized, while at the ED frame, the volume of the LV is maximized. The ratio between this minimum and maximum volume reading represents the ejection ratio, which is an important characterization of the LV function.

In order to determine the ejection ratio, the medical practitioner may examine the ES and ED frames of the cardiac ultrasound and manually identify the bounds of the LV. Once identified, the medical practitioner may measure the respective LV volumes and calculate the ejection ratio.

In addition to determining the ejection ratio, it may be desirable to calculate the volume curve for the LV throughout the entire cardiac cycle. The volume curve is a representation of the LV volume, not only at the ES and ED, but at every point in the cardiac cycle. However, because of the large number of image frames, manually identifying the bounds of the LV for each frame may be time consuming and prone to error.

Computer assisted techniques have been developed to segment the LV within each frame of the cardiac ultrasound. Many of these approaches utilize a tracking system whereby the medical practitioner manually identifies the LV in one or more frames, generally the ES frame and the ED frame, and the computer system uses these identifications to predict an approximate segmentation for a next frame. Prediction thus provides an approximation of where the LV is expected to be found given the segmentation of the LV in the previous frame. The computer system may then perform a correction to enhance the accuracy of the initial segmentation approximation, and this corrected segmentation may then be further predicted to form a basis for segmentation in the following frame. In this way, the manually identified LV may be tracked from the first frame to the last frame. Thus, the manual segmentation at frame t₀ is predicted to form an initial approximation for the segmentation of frame t₁. The initial approximation is then enhanced to provide the final segmentation of frame t₁, and this final segmentation of frame t₁ is used altogether with a dynamic model to predict an initial approximation for the segmentation of frame t₂, and so on, until all frames are segmented.

Unfortunately, this approach of frame-by-frame prediction and correction introduces the possibility that a segmentation error, once introduced, will propagate from frame to frame, increasing in severity in each frame. For example, if at frame t₁, the final segmentation includes a slight error, this error will be propagated to frame t₂ where the final segmentation at frame t₁ is used to predict the next initial segmentation approximation. The error may thus be amplified at each successive frame thereby leading to erroneous results.

### SUMMARY

A method for segmenting a sequence of images includes acquiring the sequence of images showing a progression of a subject through a cycle; manually segmenting a region of interest of the subject from one or more of the images of the sequence of images; constructing an autoregressive model based on the manual segmentation of the one or more images of the sequence of images for predicting segmentation of the region of interest of the subject in each image of the sequence of images; and using the autoregressive model to perform segmentation on the region of interest of the subject for a plurality of images of the sequence of images.

The sequence of images may be a sequence of cardiac images such as a cardiac ultrasound study, the subject may be a heart, the cycle may be a cardiac cycle, and the region of interest may be a left ventricle of the heart. One or more of the images of the sequence of images that are manually segmented may be an end systolic frame representing the geometry of the left ventricle at the end of a ventricular systole stage. One or more of the images of the sequence of images that are manually segmented may be an end diastole frame representing the geometry of the left ventricle at the end of a diastole stage.

The autoregressive model may be developed using a set of training data. Constructing the autoregressive model based on the manual segmentation of the one or more images may include performing parameterization on data resulting from the manual segmentation of the one or more images of the sequence of images. The parameterization may be performed using principal component analysis.

Constructing the autoregressive model based on the manual segmentation of the one or more images may include building distance maps for data resulting from the manual segmentation of the one or more images of the sequence of images, and performing principal component analysis to express each of the distance maps in terms of a set of parameters.

A volume curve may be calculated for the left ventricle from the segmented plurality of images of the sequence of images. The morphology of the heart through the cycle may be calculated from the segmented plurality of images of the sequence of images.

Segmentation may be performed on the region of interest of the subject for the plurality of images of the sequence of images by using the autoregressive model to determine an approximate segmentation for each of the plurality of images and then determining a final segmentation for each of the plurality of images by correcting the respective approximate segmentation.

At least two of the images of the sequence of images may be manually selected and the autoregressive model is based on the at least two manual segmentations. The autoregressive model may be a linear autoregressive model and the manually segmented images are parameterized prior to constructing the autoregressive model.

Principal component analysis may be used to parameterize the manually segmented images prior to constructing the autoregressive model.

A method for segmenting a sequence of images includes developing an autoregressive model using training data including segmented images of a same type as the sequence of images; manually segmenting a region of interest from at least two images of the sequence of images; parameterizing the manually segmented images; adapting the autoregressive model to the parameterized segmented images; and using the autoregressive model to perform segmentation on the region of interest for a plurality of images of the sequence of images.

The parameterization may be performed using principal component analysis.

A computer system includes a processor and a program storage device readable by the computer system, embodying a program of instructions executable by the processor to perform method steps for segmenting a sequence of images. The method includes manually segmenting a region of interest from one or more of the images of the sequence of images; constructing an autoregressive model based on the manual segmentation of the one or more images of the sequence of images for predicting segmentation of the region of interest of the subject in each image of the sequence of images; and using the autoregressive model to perform segmentation on the region of interest of the subject for a plurality of images of the sequence of images.

The sequence of images may be a sequence of cardiac images, the cycle is a cardiac cycle, and the region of interest is a left ventricle of the heart.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a flow chart illustrating a method for segmenting cardiac ultrasound images using a dynamic model of the LV according to an exemplary embodiment of the present invention;

FIG. 2 is a flow chart illustrating an approach for developing the dynamic model according to exemplary embodiments of the present invention;

FIG. 3 is an illustration of a distance map according to an exemplary embodiment of the present invention;

FIG. 4 is a graph illustrating main PCA coefficients for three ventrical shapes through the cardiac cycle according to an exemplary embodiment of the present invention;

FIG. 4 shows an example of a computer system capable of implementing the method and apparatus according to embodiments of the present disclosure;

FIG. 5 is a flow chart illustrating a method for establishing an autoregressive model for each PCA parameter according to an exemplary embodiment of the present invention; and

FIG. 6 shows an example of a computer system capable of implementing the method and apparatus according to embodiments of the present disclosure.

### DETAILED DESCRIPTION OF THE DRAWINGS

In describing the exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention seek to provide an approach to computer-assisted segmentation of cardiac ultrasound images, for example, to determine the cardiac volume curve of the left ventricle (LV), where segmentation error is not propagated from frame to frame.

Exemplary embodiments of the present invention may utilize a dynamic model of the LV to predict expected LV segmentation results for the cardiac ultrasound image frames and these predictions may be automatically refined to produce a final segmentation. Because the expected segmentation for each frame is provided by the dynamic model and is not necessarily based on the segmentation of the previous frame, segmentation errors are not propagated and amplified from frame to frame.

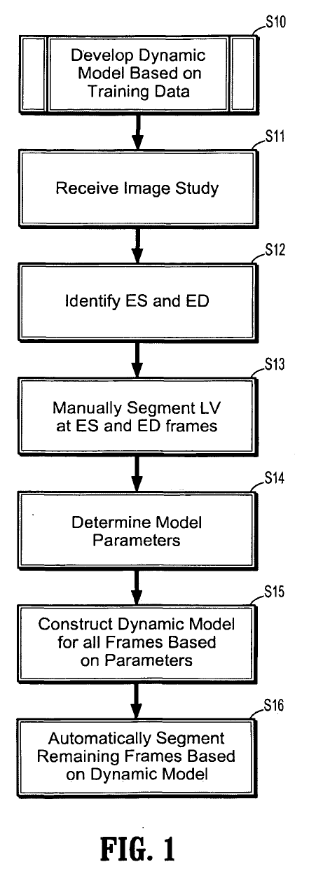

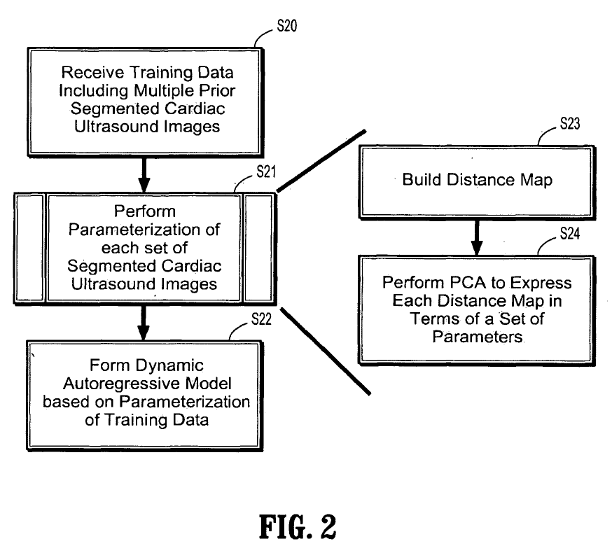

FIG. 1 is a flow chart illustrating a method for segmenting cardiac ultrasound images using a dynamic model of the LV according to an exemplary embodiment of the present invention. The first step may be to develop the dynamic model (Step S10). The dynamic model may be based on training data that includes sets of segmented cardiac ultrasound images. Exemplary methods for the development of the dynamic model are discussed in greater detail below with reference to FIG. 2.

After the dynamic model of the LV has been developed, a subject cardiac ultrasound study may be received (Step S11). The subject cardiac ultrasound study may be received either from a medical image database or may be directly received from an ultrasound imager by the administration of an echocardiogram. Next, the ES and ED image frames may be identified (Step S12). As discussed above, the end systolic (ES) frame represents the geometry of the LV at the end of the ventricular systole stage and an end diastole (ED) frame representing the geometry of the LV at the end of the diastole stage. At the ES frame, the volume of the LV is minimized, while at the ED frame, the volume of the LV is maximized. The ES and ED frames may be either automatically or manually identified.

Segmentation of the ES and ED image frames is describe by way of example, and other exemplary embodiments of the present invention may more generally have any predetermined number of images segmented per heart beat sequence. For example, there may be two images sequenced (as described above) or some other number of images may be segmented per heart beat sequence.

After the ES and ED frames have been identified, the LV may be segmented for each of the identified frames (Step S13). Segmentation may be performed either manually or with a computer aided diagnostic (CAD) tool. Manual segmentation may include making a determination as to what region of the frames includes the LV. This may be performed, for example, by having the user trace the bounds of the LV within the computer system displaying the image data. Where a CAD tool is used, the computer system may assist in this manual segmentation, for example, by identifying the bounds after the user has identified one or more points on the image that are part of the LV. The user may revise the assisted segmentation where appropriate.

In the performance of a standard cardiac ultrasound, the ES and the ED are commonly identified and segmented by the medical practitioner. Accordingly, no additional burden may be placed upon the medical practitioner by the practice of the present exemplary embodiment.

The segmented ES and ED frames may be used to apply the dynamic model to the subject cardiac ultrasound study, however, these frames are offered as a convenient example because of the preexisting practice of manually identifying and segmenting these frames. However, as discussed above, one or more different frames may be used for this purpose instead of or in addition to the ES and ED frames. Moreover, exemplary embodiments of the present invention may use one of the ES and ED frames with or without one or more other frames. Thus any one or more of the frames may be used, and implementation need not be limited to the use of the ES and ED frames.

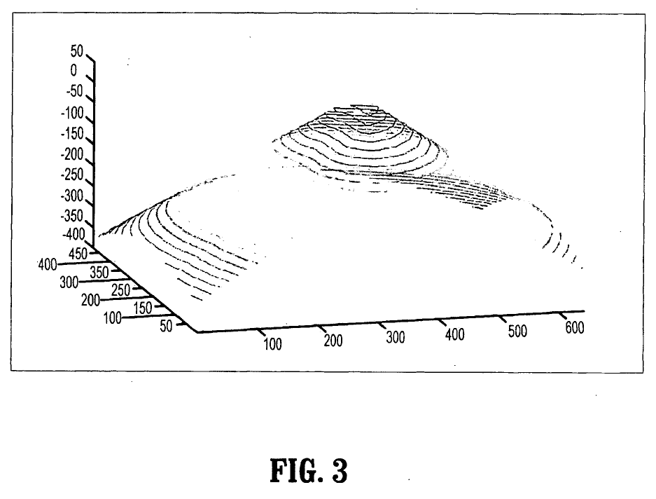

Next, one or more model parameters may be determined based on the manually segmented frames (Step S14). Parameterization may be performed based on a distance map. The distance map is a representation of each image pixel in terms of its distance from the boundary defining the LV within the image data. Each pixel on the boundary may be represented by a zero-value. Those pixels one unit away from the closest boundary are assigned a value of +1 if they are beyond the boundary and −1 if they are within the boundary. Those pixels two units away from the closest boundary are assigned a value of +2 if they are beyond the boundary and −2 if they are within the boundary, and so on. Accordingly, distance maps are defined as the signed (positive or negative) Euclidian distance between each pixel and the boundary. FIG. 3 is an illustration of a distance map according to an exemplary embodiment of the present invention.

After the segmented frames are represented by distance maps X, a statistical process, for example, Principal Component Analysis (PCA) may be used to extract from the segmented image frames, those parameters that may be used to fit the instant cardiac ultrasound study to the predefined dynamic model. This may be accomplished, for example, by registering the contours of the LV boundary to the alignment space used in PCA, and the registered distance maps corresponding to the boundary contours may be projected on the PCA space. The result of the projection may be a set of PCA coefficients Y(t) that correspond to the segmented contour in the sequence at time t.

Next, the determined parameters may be used to fit the segmented frame data to the predefined dynamic model and to provide predictions for the segmentation of the LV throughout each frame of the cardiac cycle (Step S15). These segmentation predictions may then be used, at each frame, to automatically segment the LV at each frame of the image study (Step S16). Automatic segmentation may be performed using the segmentation prediction for the particular frame as a first-order approximation of the segmentation, and then the segmentation may be enhanced and/or corrected. However, because the predicted segmentation for each frame is based on the dynamic model rather than a segmentation of a previous frame, any potential errors are not carried forward from frame to frame, and thus errors are not amplified.

As discussed above, a dynamic model may be developed based on multiple sets of training data. FIG. 2 illustrates an approach for developing the dynamic model according to exemplary embodiments of the present invention. First, the training data is received (Step S20). The training data may include one or more prior cardiac ultrasound studies where the LV has been accurately segmented. For example, the LV in each image frame may be manually segmented by an expert. The training data may also include complete volume curves for each set of training data. Next, parameterization may be performed for each set of training data (Step S21). In parameterization, each set of training data is expresses as a mathematical relationship of various parameters, the parameters being components that most heavily influence the characteristics of the training data. Thus, each complex set of training data may be expressed more simply in terms of the parameters. This results in a reduction of the dimensionality of the data, simplifying analysis of the data.

The performance of parameterization (Step S21) may include building of a distance map (Step S23) and the performance of principal component analysis (PCA) to express each distance map in terms of a set of parameters (Step S24). As discussed above, the distance map is a representation of each image pixel in terms of its distance from the boundary defining the LV within the image data, with each pixel associated with a signed Euclidean distance to the LV boundary contour. Multiple distance maps may be geometrically registered together using translation and scaling.

PCA is a statistical technique that may be used to reduce multidimensional data sets to lower dimensions for simplified analysis. In PCA, an input vector X may be projected onto an orthogonal basis, whose axes correspond to the statistical mode of the variation of X. The basis' axes may be the Eigenvectors of the covariance matrix of X. The Eigenvalue associated to each of the Eigenvectors may be proportional to the amount of variation that occurs along that particular axis/Eigenvector. Accordingly, Eigenvectors associated with low variations may be neglected. Thus, the dimensionality of the data sets may be reduced.

For example, X₁, X₂, . . . Xₘ may be taken as m data sets of LV segmentations in apical four chambers view, represented using the distance maps described above. The distance maps may be expressed as vectors by ordering the pixels in lexicographic order. For example, for ultrasound images of size 480×640, these vectors may be column vectors of 307200 rows. Dimension reduction may then be performed. First, the mean distance map X̅ may be computed as the average of all distance maps X₁, X₂, . . . Xₘ. Then the covariance matrix of X₁, X₂, . . . Xₘ may therefore become M=[(X₁− X̅)(X₂− X̅)(Xₘ− X̅)][(X₁− X̅)(X₂− X̅)(Xₘ− X̅)]^{T}, where C^{T} denotes the transposition of matrix C for any matrix C.

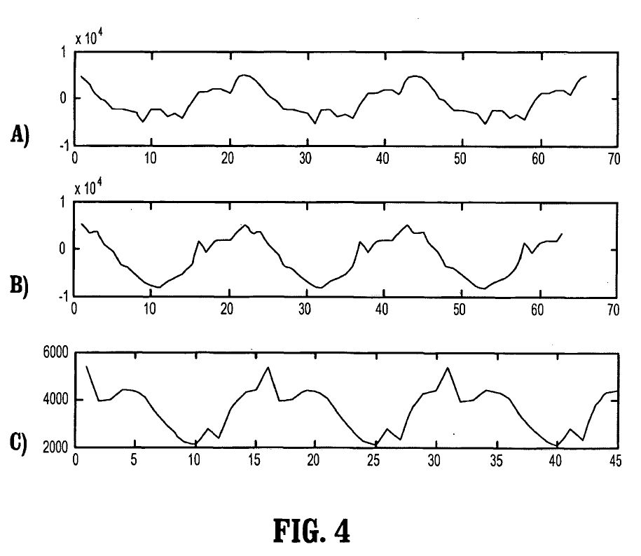

Consequentially, a basis B={B₁, B₂, . . . B_{N}} of N axes may be determined wherein N<<307200, and the parameters (y₁, y₂, . . . y_{N}) that define a particular contour X are computed by projecting the contour X onto each axis of B. Here, the parameters of X may be noted Y=[y₁, y₂, . . . y_{N}]^{T} with the following relationship: X≈ X̅+ΣᵢyᵢBᵢ. FIG. 4 is a graph illustrating main PCA coefficients for three ventrical shapes through the cardiac cycle. Three heartbeats (A, B and C) are illustrated for each ventricle. As can be seen from FIG. 4, the parameters may form the time series specific to the cardiac cycle whose dynamic is modeled by an autoregressive model.

In building the distance map (Step S23), the contour of the LV segmentation (C) may be represented by the zero level-set of a function A, where F represents the image region inside the LV and D(x) is the Euclidean distance between a point p and the curve C, accordingly:

$$ψ ( p ) = \{ \begin{matrix}0 & , p ∈ C \\ + D ( p ) > 0 & , p ∈ Γ \\ - D ( p ) < 0 & , p ∈ \overline{Γ}\end{matrix}$$

In performing PCA to express each distance map in terms of a set of parameters (Step S24), the distance map is projected into a lower dimensional feature space by rewriting the high-dimensional vector X as the sum of a mean vector X̅ and a linear combination of the principal modes of variation. Here, Eigenanalysis of the covariance matrix may be used to determine the orthogonal basis formed by the matrix Eigenvectors, and the Eigenvalues associated to them. This orthogonal basis may be composed of the modes of variation, and the variations amplitude may be given by the Eigenvalues associated with each Eigenvector/mode.

The dynamic autoregressive model may be formed based on the parameterization of the training data (Step S22). Sequences of distance maps X(t) may be parameterized using Principal Component Analysis, leading to sequences of parameters vectors Y(t). Autoregressive models may be predictive models that use past instances of vector sequence Y(t) to predict the future states of Y(t), for example:

Y(t)=A₁Y(t−1)+A₂Y(t−2)+ . . . AₚY(t−p)+w

where p represents the order of the autoregressive model. Thus, an autoregressive model may be established for each of the p parameter.

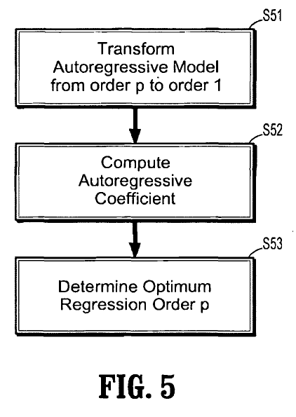

FIG. 5 is a flow chart illustrating a method for establishing an autoregressive model for each PCA parameter according to an exemplary embodiment of the present invention. First, the autoregressive model may be transformed from order p to order 1 (Step S51). Next, the autoregressive coefficients may be calculated (Step S52). Then, the optimum regression order p is determined as the number of non-null Eigenvalues of B (Step S53). As an alternative to counting the non-null Eigenvalues, Eigenvalues over a predetermined threshold may be counted.

As discussed above, to establish the autoregressive model, the manually segmented cardiac ultrasound images expressed as distance maps may first be expressed parametrically. When the contours X₁, X₂, . . . Xₘ are represented parametrically, the regression of the input signals Yₜ may be as follows:

Yₜ=A₁Yₜ₋₁+A₂Yₜ₋₂+ . . . AₖYₜ₋ₖ+εₜ

where εₜ denotes the error between the predicted and actual segmentation.

Where {Xᵢ, iε[|1,N|]} is the set of high dimensional vectors, X̅ is the mean of these vectors and

M=[(X₁− X̅)(X₂− X̅) . . . (X_{N}− X̅)][[(X₁− X̅)(X₂− X̅) . . . (X_{N}− X̅)]^{T}

is the covariance matrix. Given that M is a symmetric real positive definite matrix, its Eigenvalues may be noted as λ₁>λ₂> . . . λ_{N}>0 and the corresponding Eigenvectors {Bᵢ, iε[|1,N|]}. Here, A is the diagonal matrix composed of Eigenvalues, and B=[B₁ B₂ . . . B_{N}], thus:

M=BΛB^{T}

For each PCA parameter yᵢ, the actual interpolation using the Autoregressive Model may be performed in the following way. To each distance map X(t) in the sequence at time t is associated a parameter yᵢ(t) that corresponds to the ith Eigenvector (mode of variation) Bᵢ. Let matrix Yᵢ=[yᵢ(0) yᵢ(1) . . . yᵢ(T)] and let matrix A denote the diagonal elements of AᵢYᵢ. Then, the noise vector ε=[ε₁, ε₂, . . . ε_{T}] verifies

ε=AY

Now, assuming for instance that the user has manually segmented n contours Xₜ₁, Xₜ₂ Xₜₙ then let U (resp. K) be a rearrangement matrix of identity matrix I composed by the k columns of I whose indices correspond (resp. do not correspond) to t₁, t₂, . . . tₙ. Let Ys be the input signal composed by the elements of Y that are initialized (at t₁, t₂, . . . tₙ), and Yo the vector composed by the elements to be determined. Then, the PCA parameters for the interpolated contours may be computed as follows:

Yo=−(AKK^{T}A^{T})⁻¹K^{T}A^{T}AUYs

Exemplary embodiments of the present invention may be performed using a wide variety of ultrasound imaging devices and methods. These various methods for obtaining ultrasound images may use different ultrasound protocols, and different ultrasound protocol might not have the same sampling frequency. Additionally, not all hearts beat at the same rate. Thus, it should not be assumed that in all cardiac ultrasound studies, the length of time between image frames is consistent from study to study. Accordingly, an electrocardiograph (ECG) may be used to calibrate the dynamic model to the current heart beat frequency so that variances in the length of time between image frames may be accounted for. One exemplary approach to performing calibration is to acquire the heart beat in terms of beats-per-minute (BPM) and resample the autoregressive model on the heart rate frequency.

Thus in exemplary embodiments of the present invention, an autoregressive model may be used to predict the entire sequence of image frames and LV segmentation need not be based on segmentation of a previous frame. The segmentation predicted by the autoregressive model may either be used as the final segmentation or the prediction may be used as an approximation that is later improved. In either event, after segmentation has been finalized, LV volume may be calculated and a volume curve for the complete study may be produced. The volume curve may then be used for diagnostic purposes.

Because a single autoregressive model is used to predict the LV segmentation for each cardiac ultrasound, segmentation error does not increase from frame-to-frame, as would be possible for prior approaches.

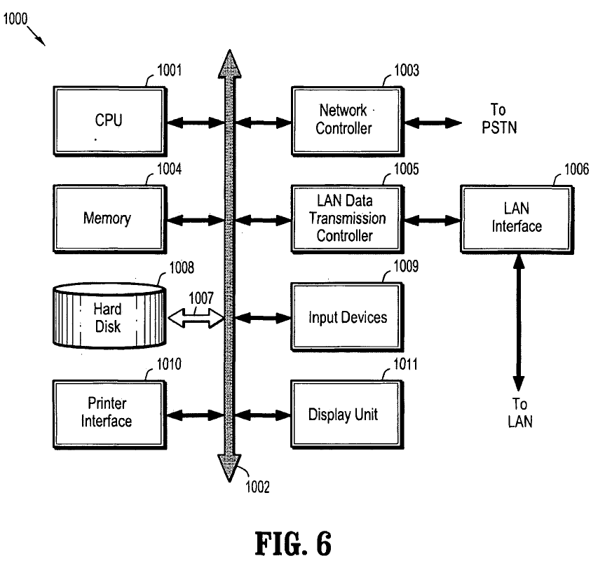

FIG. 6 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific exemplary embodiments are illustrative, and many variations can be introduced on these embodiments without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for segmenting a sequence of images, comprising:
acquiring the sequence of images showing a progression of a subject through a cycle;
manually segmenting a region of interest of the subject from one or more of the images of the sequence of images;
constructing an autoregressive model based on the manual segmentation of the one or more images of the sequence of images for predicting segmentation of the region of interest of the subject in each image of the sequence of images; and
using the autoregressive model to perform segmentation on the region of interest of the subject for a plurality of images of the sequence of images.

2. The method of claim 1, wherein the sequence of images is a sequence of cardiac images, the subject is a heart, the cycle is a cardiac cycle, and the region of interest is a left ventricle of the heart.

3. The method of claim 1, wherein the sequence of images is a cardiac ultrasound study, the subject is a heart, the cycle is a cardiac cycle, and the region of interest is a left ventricle of the heart.

4. The method of claim 2, wherein the one or more of the images of the sequence of images that are manually segmented include an end systolic frame representing the geometry of the left ventricle at the end of a ventricular systole stage.

5. The method of claim 2, wherein the one or more of the images of the sequence of images that are manually segmented include an end diastole frame representing the geometry of the left ventricle at the end of a diastole stage.

6. The method of claim 1, wherein the autoregressive model is developed using a set of training data.

7. The method of claim 1, wherein constructing the autoregressive model based on the manual segmentation of the one or more images includes performing parameterization on data resulting from the manual segmentation of the one or more images of the sequence of images.

8. The method of claim 7, wherein the parameterization is performed using principal component analysis.

9. The method of claim 1, wherein constructing the autoregressive model based on the manual segmentation of the one or more images includes building distance maps for data resulting from the manual segmentation of the one or more images of the sequence of images, and performing principal component analysis to express each of the distance maps in terms of a set of parameters.

10. The method of claim 2, additionally including calculating a volume curve for the left ventricle from the segmented plurality of images of the sequence of images.

11. The method of claim 2, additionally including calculating the morphology of the heart through the cycle from the segmented plurality of images of the sequence of images.

12. The method of claim 1, wherein segmentation is performed on the region of interest of the subject for the plurality of images of the sequence of images by using the autoregressive model to determine an approximate segmentation for each of the plurality of images and then determining a final segmentation for each of the plurality of images by correcting the respective approximate segmentation.

13. The method of claim 1, wherein at least two of the images of the sequence of images are manually selected and the autoregressive model is based on the at least two manual segmentations.

14. The method of claim 1, wherein the autoregressive model is a linear autoregressive model and the manually segmented images are parameterized prior to constructing the autoregressive model.

15. The method of claim 14, wherein principal component analysis is used to parameterize the manually segmented images prior to constructing the autoregressive model.

17. A method for segmenting a sequence of images, comprising:
developing an autoregressive model using training data including segmented images of a same type as the sequence of images;
manually segmenting a region of interest from at least two images of the sequence of images;
parameterizing the manually segmented images;
adapting the autoregressive model to the parameterized segmented images; and
using the autoregressive model to perform segmentation on the region of interest for a plurality of images of the sequence of images.

18. The method of claim 17, wherein the parameterization is performed using principal component analysis.

19. A computer system comprising:
a processor; and
a program storage device readable by the computer system, embodying a program of instructions executable by the processor to perform method steps for segmenting a sequence of images, the method comprising:
manually segmenting a region of interest from one or more of the images of the sequence of images;
constructing an autoregressive model based on the manual segmentation of the one or more images of the sequence of images for predicting segmentation of the region of interest of the subject in each image of the sequence of images; and
using the autoregressive model to perform segmentation on the region of interest of the subject for a plurality of images of the sequence of images.

20. The computer system of claim 19, wherein the sequence of images is a sequence of cardiac images, the cycle is a cardiac cycle, and the region of interest is a left ventricle of the heart.
